(19) United States
(12) Patent Application Publication
(10) Pub. No.: US 2016/0004823 A1
(43) Pub. Date: Jan. 7, 2016

(54) INTEGRATED METHOD AND SYSTEM FOR CREATING, GENERATING (PRINTING), MANAGING, AND TRACKING AUTHORIZATIONS TO RELEASE INFORMATION TO THIRD PARTIES

(71) Applicant: Justician Holdings, LLC, New York City, NY (US)

(72) Inventors: Herbert Subin, Scarsdale, NY (US); Neal Magnus, Montvale, NJ (US)

(21) Appl. No.: 14/856,321

(22) Filed: Sep. 16, 2015

Related U.S. Application Data
(63) Continuation of application No. 13/159,299, filed on Jun. 13, 2011.
(60) Provisional application No. 61/354,660, filed on Jun. 14, 2010.

(51) Int. Cl. G06F 19/00

(52) U.S. Cl. CPC G06F 19/322

(57) ABSTRACT

A method and system for preparing release of information documents is disclosed. The method includes receiving first information identifying a particular legal matter, receiving second information identifying one or more clients associated with the particular legal matter, receiving third information identifying a plurality of sources of medical information requiring a release of information document, and receiving fourth information identifying at least one recipient to which said medical information is to be provided. The method further includes batch processing, via a processor, the received first, second, third and fourth information, and generating, via the processor, at least a release of information document for each of the plurality of sources.

### CROSS-REFERENCE TO RELATED APPLICATION

This application claims the benefit of U.S. Provisional Application No. 61/354,660, filed Jun. 14, 2010, which is hereby incorporated by reference in its entirety.

### BACKGROUND

1. Field

The disclosed technology relates to a method and system for generating release of information documents authorizing the release of information to third parties. In some embodiments, the technology relates to methods and systems for creating, generating, printing, managing, and tracking authorizations to release information to third parties. In certain embodiments, the disclosed technology relates to a method and system for the integrated management of creating, generating, printing, managing, and tracking the documents required to release information to a third party.

2. Description of the Related Technology

One problem in the legal and insurance industry today is that no integrated method and system exists to create, generate, manage, and track the documents required to allow an entity to release information, which may potentially be confidential, to a third party. Currently, for example, a law firm in the furtherance of a case may be required to obtain the medical records of its client from several different healthcare providers, hospitals, and pharmacies, or alternatively, the law firm might be seeking their client's cell phone records. In order for the holder of such records to release the information to the requesting law firm or to anyone else for that matter, they often must receive written permission to do so. In the above or related circumstances, the law firm must generate a document (a Release of Information Document “RID”) to be executed by its client instructing the holder of the sought after records to release them. Law firm and insurance company personnel are often not adequately trained to determine the appropriate form of the RID to use for each of the varied holders of information. Furthermore, performance of these actions is not related to the core functions of law firm or insurance company staff.

Due to the labor-intense nature of RIDs and determining if the sought after information has indeed been returned, the process is inordinately time consuming and expensive and may delay the prosecution of cases or the binding of insurance policies.

There is a need in the art, therefore, for a method and system for the integrated creation, printing, and managing, of RIDs and tracking whether the requested information has been returned.

### SUMMARY OF CERTAIN INVENTIVE ASPECTS

Some embodiments of the present invention are described below.

In one embodiment there is a computerized method of preparing release of information documents in a system having a processor and a storage, the method comprising receiving first information identifying a particular legal matter; receiving second information identifying one or more clients associated with the particular legal matter; receiving third information identifying a plurality of sources of medical information requiring a release of information document; receiving fourth information identifying at least one recipient to which said medical information is to be provided; batch processing the received first, second, third and fourth information; and generating at least a release of information document for each of the plurality of sources.

The method may additionally comprise receiving fifth information identifying particular data to be requested from the plurality of sources, and may further comprise receiving particular released records, each particular record comprising the requested particular data, from at least a portion of the plurality of sources. The method may additionally comprise storing data indicative of each released record for the particular legal matter. The method may additionally comprise, after a predetermined time interval, regenerating at least the release of information document for all sources that did not release records. The regenerating may be based at least in part on stored data indicative of each requested record which has not been released for the particular legal matter. The method may additionally comprise printing a power of attorney document. The method may additionally comprise printing a generated release of information document. Batch processing may include processing the received first, second, third and fourth information as a batch without manual intervention. The method may additionally comprise selecting one or more of the generated release of information documents as a set for printing, and printing the selected set of documents. The method may additionally comprise assigning a unique request identifier for each request of release of information. The method may additionally comprise storing the unique request identifier for each request of release of information, and determining whether the requested information associated with the request identifier has been received.

In another embodiment, there is a computerized system for preparing release of information documents, the system comprising a storage device; a processor in data communication with the storage device, wherein the processor: receives first information identifying a particular legal matter; receives second information identifying one or more clients associated with the particular legal matter; receives third information identifying a plurality of sources of medical information requiring a release of information document; receives fourth information identifying at least one recipient to which said medical information is to be provided; batch processes the received first, second, third and fourth information; and generates at least a release of information document for each of the plurality of sources.

The processor may additionally receive fifth information identifying particular data to be requested from the plurality of sources. The processor may additionally receive particular released records, each particular record comprising the requested particular data, from at least a portion of the plurality of sources. The processor may additionally regenerate, after a predetermined time interval, at least the release of information document for all sources that did not release records. The system may initiate a command for printing a generated release of information document.

In another embodiment, there is a non-transitory computer readable medium storing computer readable program code embodied therein for preparing release of information documents, the computer readable code comprising instructions which when executed by a processor perform the method of receiving first information identifying a particular legal matter; receiving second information identifying one or more clients associated with the particular legal matter; receiving third information identifying a plurality of sources of medical information requiring a release of information document; receiving fourth information identifying at least one recipient to which said medical information is to be provided; batch processing the received first, second, third and fourth information; and generating at least a release of information document for each of the plurality of sources.

In yet another embodiment, there is a computerized system for preparing release of information documents, the system comprising means for receiving first information identifying a particular legal matter; means for receiving second information identifying one or more clients associated with the particular legal matter; means for receiving third information identifying a plurality of sources of medical information requiring a release of information document; means for receiving fourth information identifying at least one recipient to which said medical information is to be provided; means for batch processing the received first, second, third and fourth information; and means for generating at least a release of information document for each of the plurality of sources.

### BRIEF DESCRIPTION OF THE DRAWINGS

FIG. 1 is a block diagram of an example configuration of an embodiment of a system for creating and processing documents.

FIGS. 2A and 2B are an example of one embodiment of a flow diagram of the functions performed by the example embodiment of the system shown in FIG. 1.

FIG. 3 is a block diagram of an example configuration of components of an embodiment of a portion of the system shown in FIG. 1.

FIGS. 4A and 4B are example screen displays that allow a user to add a new case or edit an existing case using the system shown in FIG. 1.

FIGS. 5A and 5B are example screen displays that allow demographic information regarding the clients involved in the case to be entered or edited using the system shown in FIG. 1.

FIGS. 6A, 6B and 6C are example screen displays that allow a user to identify one or more holders or sources of information being requested using the system shown in FIG. 1.

FIGS. 7A and 7B are example screen displays that allow the user to input specific information for each client that will be used to complete the Release of Information Documents (RIDs) using the system shown in FIG. 1.

FIGS. 8A and 8B are example screen displays that allow the user to preview prior to printing all of the RIDs that are included in the batch to be printed using the system shown in FIG. 1.

FIGS. 9A, 9B, 9C and 9D are example output documents generated by the system shown in FIG. 1.

### DETAILED DESCRIPTION OF CERTAIN EMBODIMENTS

The following description presents certain specific embodiments of the present invention. However, the present invention may be embodied in a multitude of different ways as described herein or as defined and covered by the claims. In this description, reference is made to the drawings wherein like parts are designated with like numerals throughout.

The system can run on any computer. An exemplary configuration of components is described herein below. The system is comprised of various modules, tools, and applications as discussed in detail below. As can be appreciated by one of ordinary skill in the art, each of the modules may comprise various sub-routines, procedures, definitional statements and macros. Each of the modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system modules, tools, and applications may be written in any programming language such as, for example, C, C++, C#, BASIC, Visual Basic, Pascal, Ada, Java, HTML, XML, Ajax or FORTRAN, and executed on an operating system, such as variants of Windows, Macintosh, UNIX, Linux, VxWorks, or other operating system. C, C++, C#, BASIC, Visual Basic, Pascal, Ada, Java, HTML, XML, Ajax and FORTRAN are industry standard programming languages for which many commercial compilers can be used to create executable code.

### DEFINITIONS

The following provides a number of examples of terms used in describing certain embodiments of the system and method.

A network may refer to a network or combination of networks spanning any geographical area, such as a local area network (LAN), wide area network (WAN), regional network, national network, and/or global network. The Internet is an example of a current global computer network. Those terms may refer to hardwire networks, wireless networks, or a combination of hardwire and wireless networks. Hardwire networks may include, for example, fiber optic lines, cable lines, ISDN lines, copper lines, etc. Wireless networks may include, for example, cellular systems, personal communications service (PCS) systems, satellite communication systems, packet radio systems, and mobile broadband systems. A cellular system may use, for example, code division multiple access (CDMA), time division multiple access (TDMA), personal digital phone (PDC), Global System Mobile (GSM), or frequency division multiple access (FDMA), among others.

A website may refer to one or more interrelated web page files and other files and programs on one or more web servers. In certain embodiments, the files and programs are accessible over a computer network, such as the Internet, by sending a hypertext transfer protocol (HTTP or HTTPS [S-HTTP]) request specifying a uniform resource locator (URL) that identifies the location of one of said web page files, wherein the files and programs are owned, managed or authorized by a single business entity. Such files and programs can include, for example, hypertext markup language (HTML) files, common gateway interface (CGI) files, and Java applications. The web page files preferably include a home page file that corresponds to a home page of the website. The home page can serve as a gateway or access point to the remaining files and programs contained within the website. In one embodiment, all of the files and programs are located under, and accessible within, the same network domain as the home page file. Alternatively, the files and programs can be located and accessible through several different network domains.

A web page or electronic page may comprise that which is presented by a standard web browser in response to an HTTP request specifying the URL by which the web page file is identified. A web page can include, for example, text, images, sound, video, and animation.

A computer or computing device may be any processor controlled device that permits access to a computer network such as the Internet, including terminal devices, such as personal computers, workstations, servers, clients, mini-computers, main-frame computers, laptop computers, a network of individual computers, mobile computers, palm-top computers, hand-held computers, set top boxes for a television, other types of web-enabled televisions, interactive kiosks, personal digital assistants (PDAs), interactive or web-enabled wireless communications devices, mobile web browsers, or a combination thereof. The computers may further possess one or more input devices such as a keyboard, mouse, touch pad, joystick, pen-input-pad, and the like. The computers may also possess an output device, such as a visual display and an audio output. One or more of these computing devices may form a computing environment.

These computers may be uni-processor or multi-processor machines. Additionally, these computers may include a non-transitory addressable storage medium or computer accessible or readable medium, such as random access memory (RAM), an electronically erasable programmable read-only memory (EEPROM), programmable read-only memory (PROM), erasable programmable read-only memory (EPROM), hard disks, floppy disks, laser disk players, digital video devices, compact disks, video tapes, audio tapes, magnetic recording tracks, memory cards, electronic networks, and other techniques to transmit or store electronic content such as, by way of example, programs and data. In one embodiment, the computers are equipped with a network communication device such as a network interface card, a modem, or other network connection device suitable for connecting to the communication network. Furthermore, the computers execute an appropriate operating system such as Linux, UNIX, any of the versions of Microsoft Windows, Apple MacOS, IBM OS/2 or other operating system. The appropriate operating system may include a communications protocol implementation that handles all incoming and outgoing message traffic passed over the network. In other embodiments, while the operating system may differ depending on the type of computer, the operating system will continue to provide the appropriate communications protocols to establish communication links with the network.

The computers may contain program logic, or other substrate configuration representing data and instructions, which cause the computer to operate in a specific and predefined manner, as described herein. In one embodiment, the program logic may be implemented as one or more object frameworks or modules. These modules may be configured to reside on the addressable storage medium and configured to execute on one or more processors. The modules include, but are not limited to, software or hardware components that perform certain tasks. Thus, a module may include, by way of example, components, such as, software components, object-oriented software components, class components and task components, processes, functions, attributes, procedures, subroutines, segments of program code, drivers, firmware, microcode, circuitry, data, databases, data structures, tables, arrays, and variables.

The various components of the system may communicate with each other and other components comprising the respective computers through mechanisms such as, by way of example, interprocess communication, remote procedure call, distributed object interfaces, and other various program interfaces. Furthermore, the functionality provided for in the components, modules, and databases may be combined into fewer components, modules, or databases or further separated into additional components, modules, or databases. Additionally, the components, modules, and databases may be implemented to execute on one or more computers.

### Description of Certain Embodiments

In the past, most of the preparation and processing of Release of Information Documents (RIDs) and associated documents is done manually without an adequate system for efficiently generating them in the proper form ideally in a batch modality, insuring that they have been properly executed, and tracking to determine if in fact the records sought in the RID have been returned.

In some instances the optimal way to print RIDs is to do so in a batch modality. For example, a single individual might have records residing with five different healthcare providers. In this circumstance it would be preferable to generate five RIDs with associated cover letters in single batch rather than individual RIDs. In addition a law firm might want to generate a Power of Attorney document concurrently with generating the RID. The system and method allows the RIDs to be generated in a batch modality and allows these ancillary documents to be generated concurrently with the RID batches. Alternatively, a law firm might want to print all RIDs that have been outstanding for a specific length of time without having received the information requested in the RID. Here again it would be preferable to print all of these RIDs in a single batch rather than printing them individually. This batch can be customized to reflect the fact that it represents a repeat request.

The system and method solves the above-identified needs, as well as others, by providing for the creating, generating, printing, managing, and tracking the documents required to release information to a third party. Further, the method and system for the generation of these documents can operate in a batch modality. The system and method also provides the users with a central data repository of potential record holders allowing the user to simply select a record holder rather than having to key in that information. Details of these and other advantages and novel features will be set forth in part in the description that follows, and in part will become more apparent to those skilled in the art upon examination of the following or upon learning by practice of the system and method.

This disclosure is not intended to limit the system and method to the integrated management of the creating, generating, printing, managing, and tracking the documents required to release information to a third party, as is more fully described herein. As will be recognized by those skilled in the art, other requests and processes may be integrated and managed using similar methods, and are intended to be included under this disclosure.

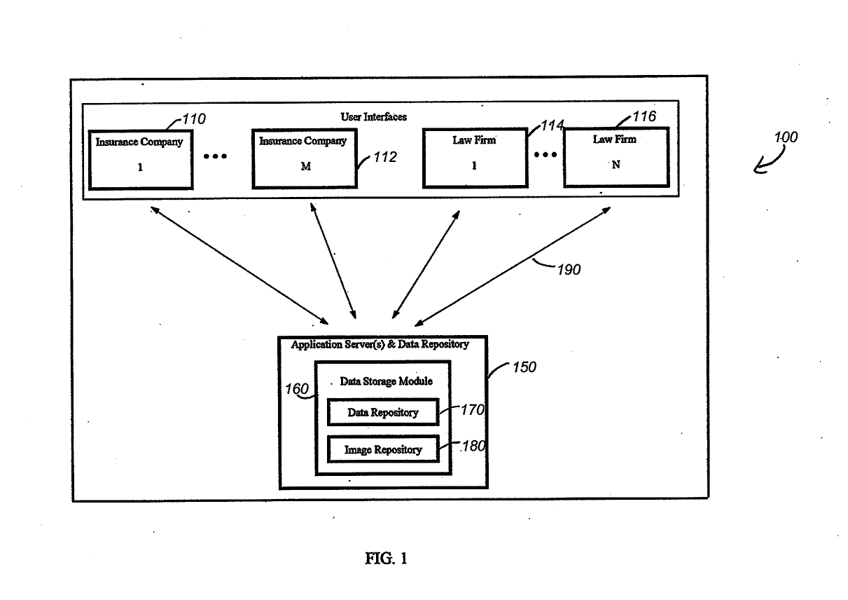

One embodiment is based on the exemplary open system integrated architecture 100 shown in FIG. 1. Referring now to FIG. 1, the exemplary open system integrated architecture 100 may be based on, for example, a User Interface interacting with a local or remote data repository and a local or remote application running on a local or remote application server, such as an application server 150. The User Interface may operate on a computer or computing device (as described above). The User Interfaces, such as interface 110 associated with insurance company 1, interface 112 associated with insurance company M, interface 114 associated with law firm 1, and interface 116 associated with law firm N, for example, have interactive connections with a Data Storage Module 160, which may contain a Data Repository 170, such as a relational database, and an Image Repository 180, such as an image array. The Data Storage Module 160 may reside in the application server 150 or may be in data communication with the application server 150. The structure and functioning of each module will be described in connection with the embodiments that follow herein.

In one embodiment, a method and system for the integrated management of creating, generating, printing, managing, and tracking the documents required to release information to a third party may be implemented as an Internet-based or other network-based system that allows an end user of the system (e.g., law firm or insurance company staff person) to input related data into the Data Repository Module 160 via the User Interface, such as one of interfaces 110-116, which is connected to the system through, for example, a secure Internet connection 190.

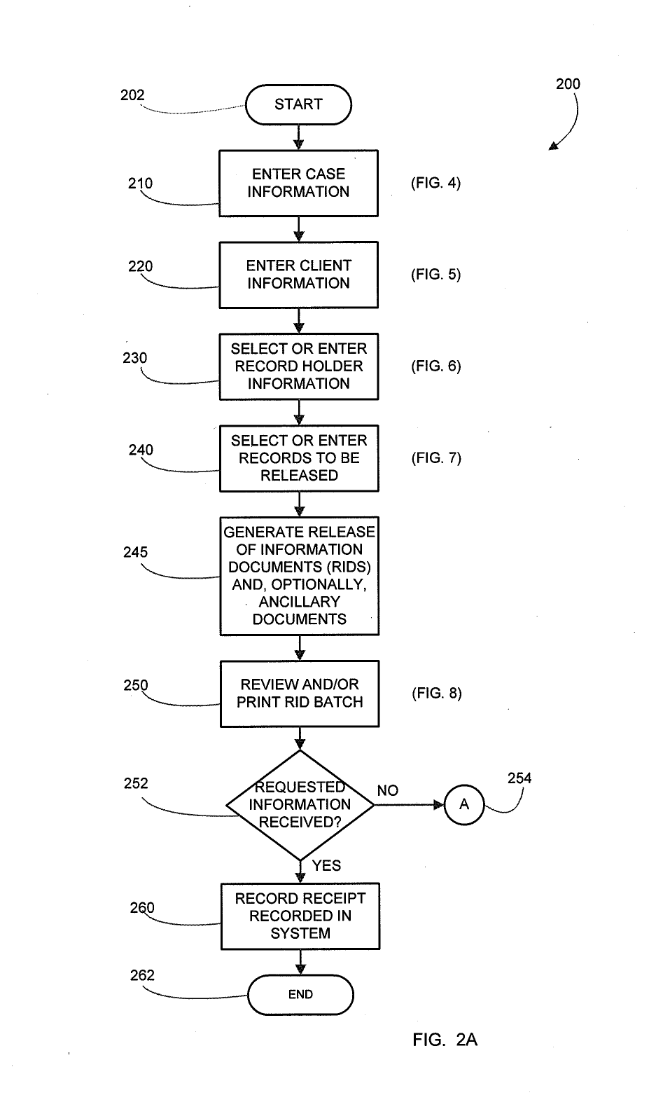

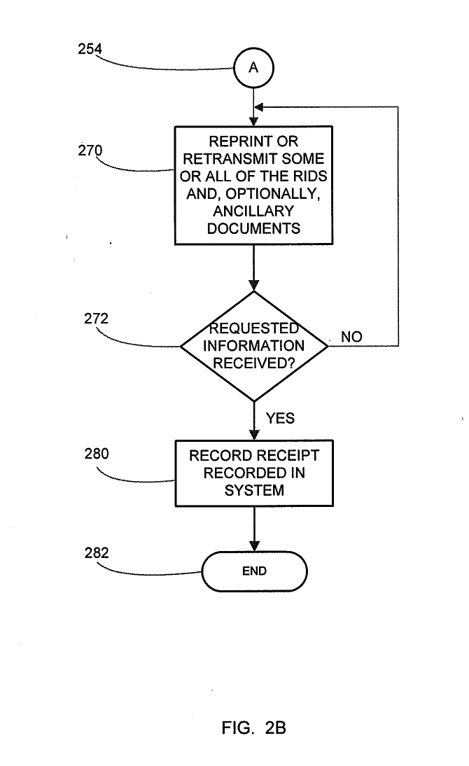

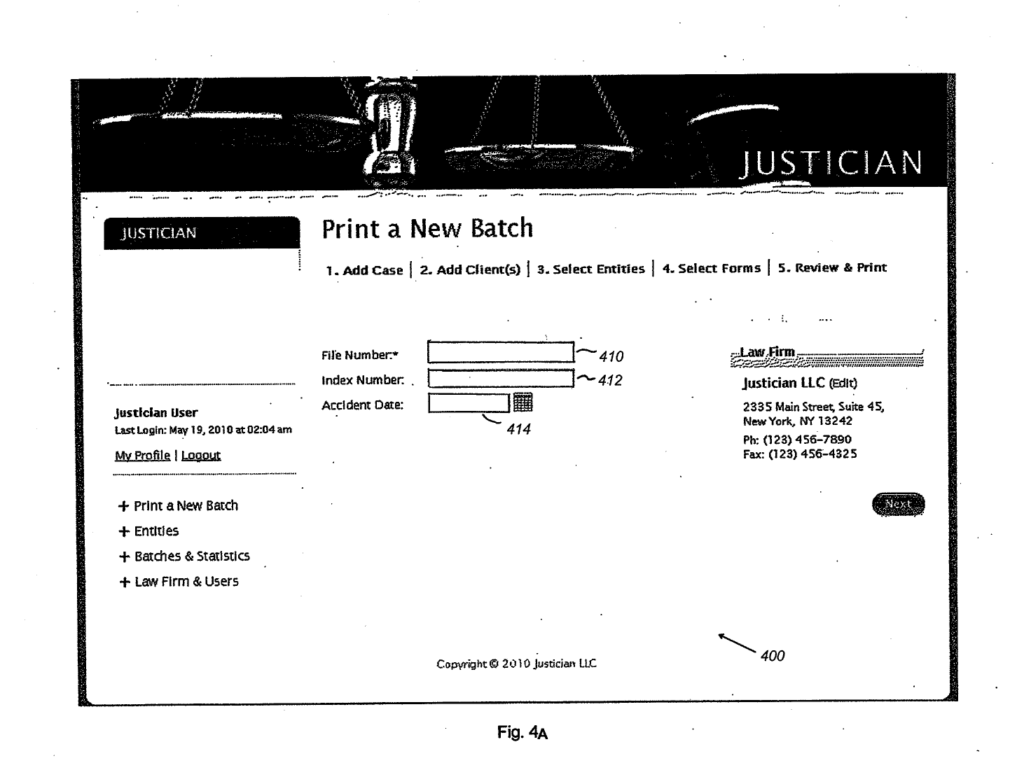

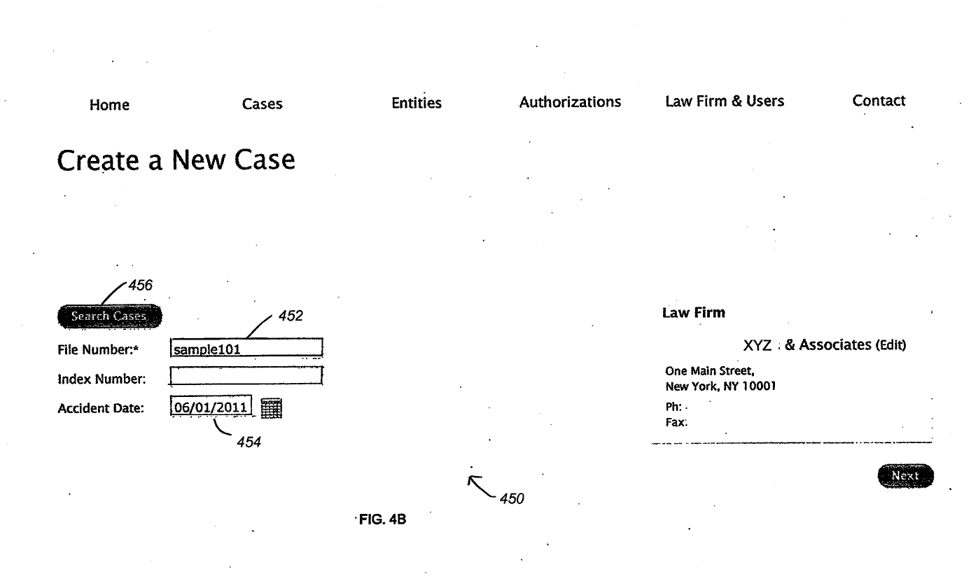

Referring to FIGS. 2A and 2B, a process 200 will be described that may operate on the architecture 100 described in FIG. 1. Beginning at a start state 202, process 200 advances to a state 210 where case information is entered, such as via one of the interfaces 110-116 (FIG. 1). FIGS. 4A and 4B show example screen displays 400 and 450, respectively, that allow a user to add a new case or edit an existing case. The example screen display can be displayed via one of the interfaces 110-116, for example. Additional detail about the screen displays 400 and 450 will be provided hereinbelow.

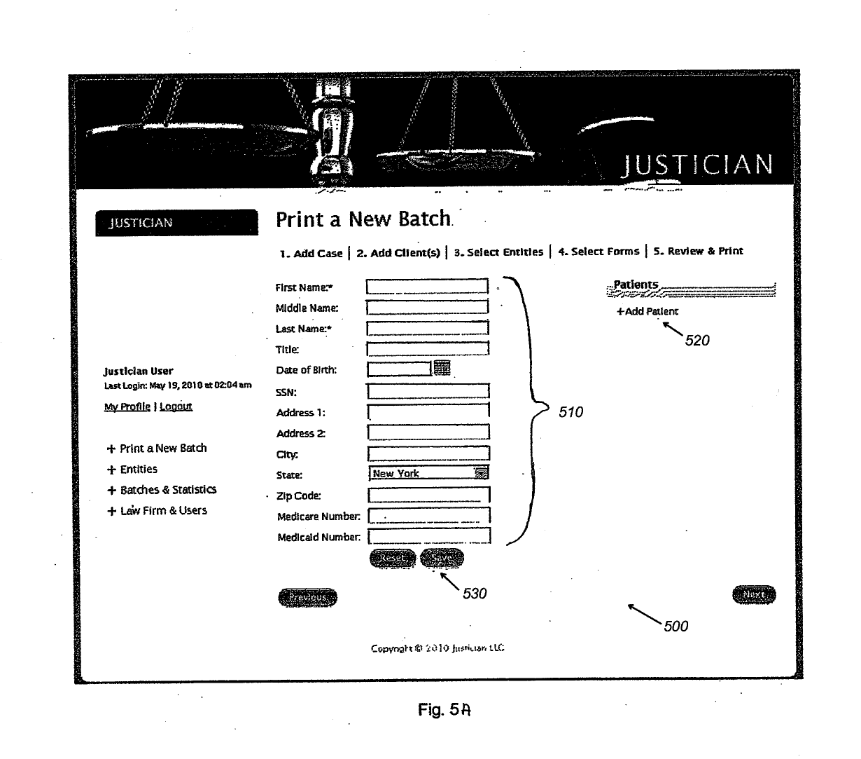

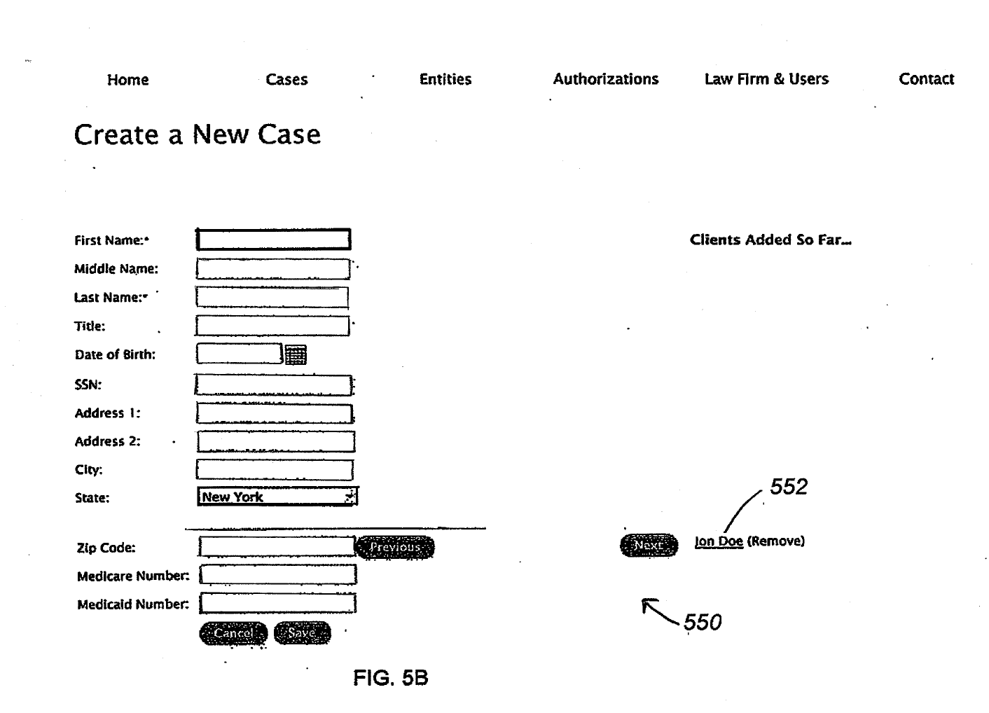

Process 200 then proceeds to state 220 where client information is entered, such as via one of the interfaces 110-116. FIGS. 5A and 5B show example screen displays 500 and 550, respectively, that allow a user to add one or more clients or patients. Additional detail about the screen displays 500 and 550 will be provided hereinbelow.

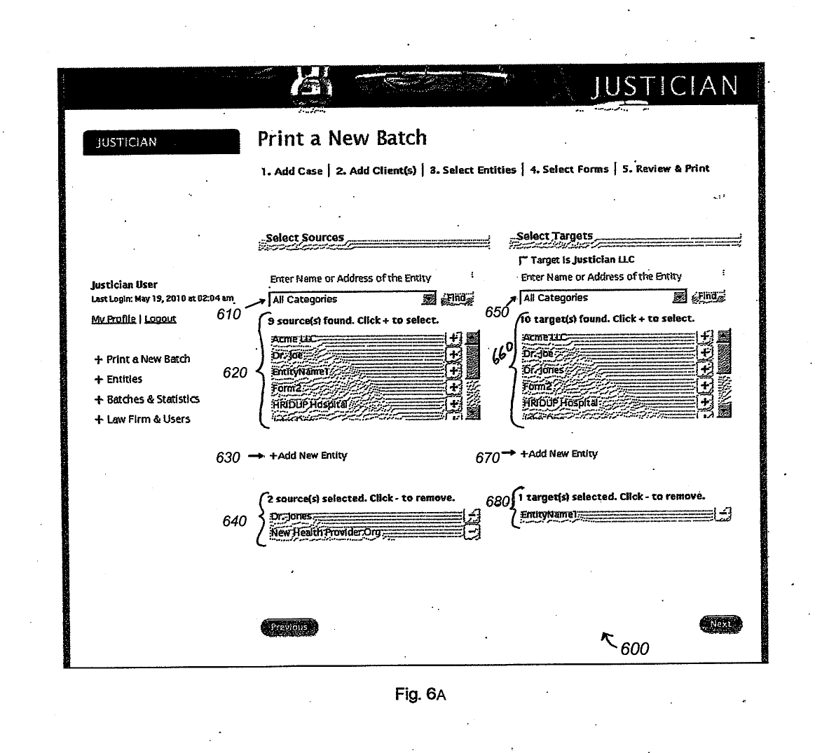

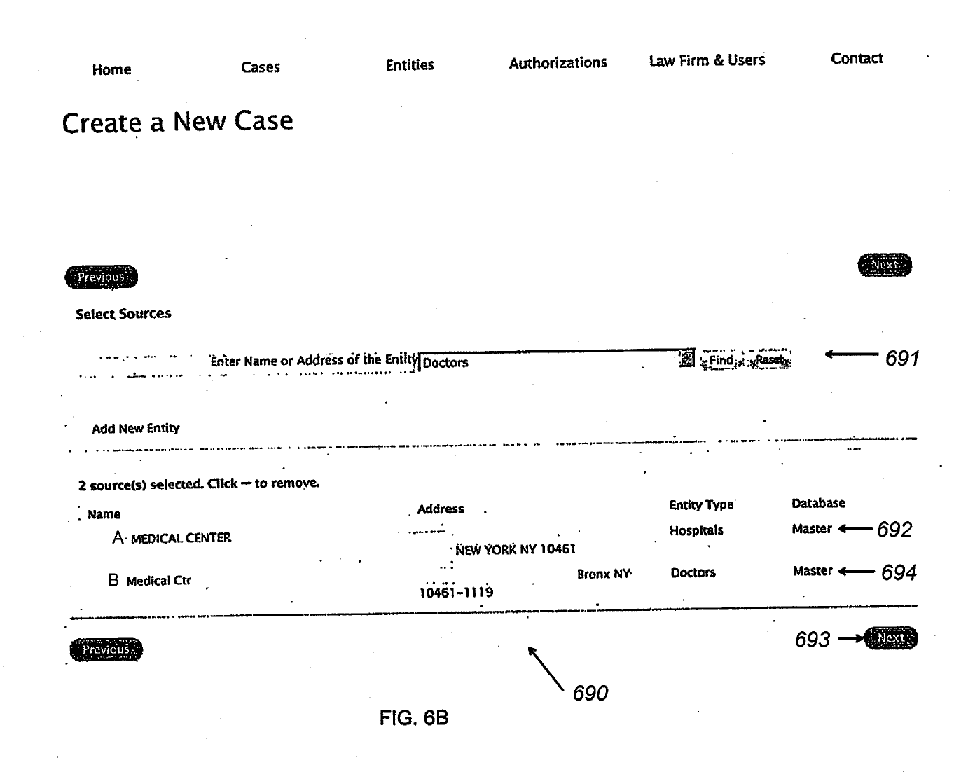

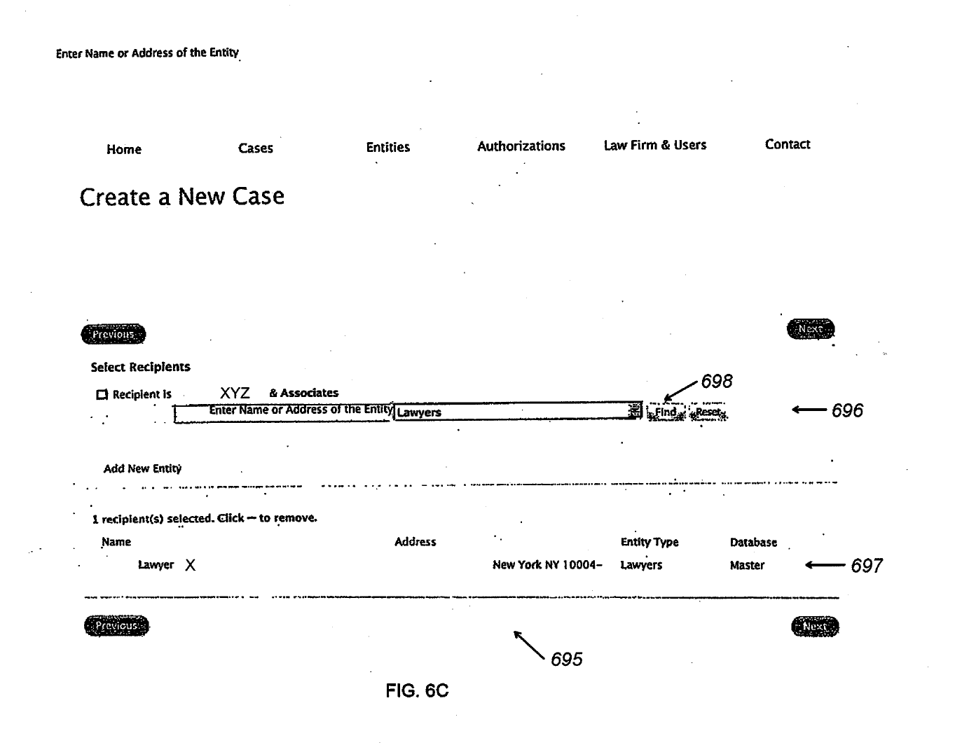

Process 200 continues to state 230, where record holder information is entered or selected, such as via one of the interfaces 110-116. FIGS. 6A, 6B and 6C show example screen displays 600, 690 and 695, respectively, that allow a user to add and/or identify one or more holders or sources for the records. In addition one or more entities or targets to which the records are to be released can be added and/or identified. Additional detail about the screen displays 600, 690 and 695 will be provided hereinbelow.

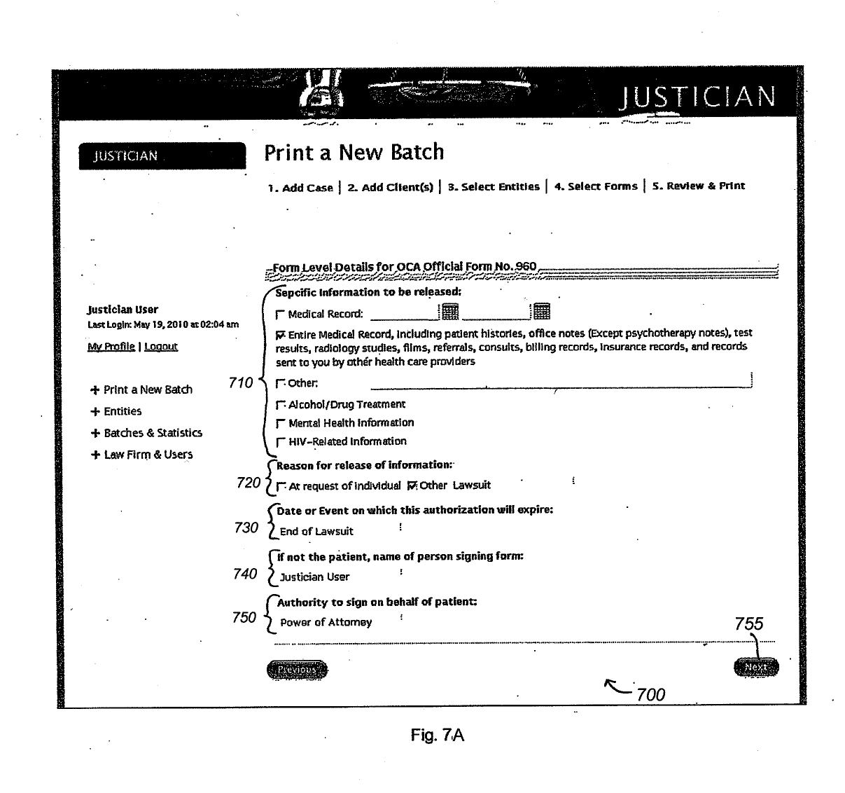

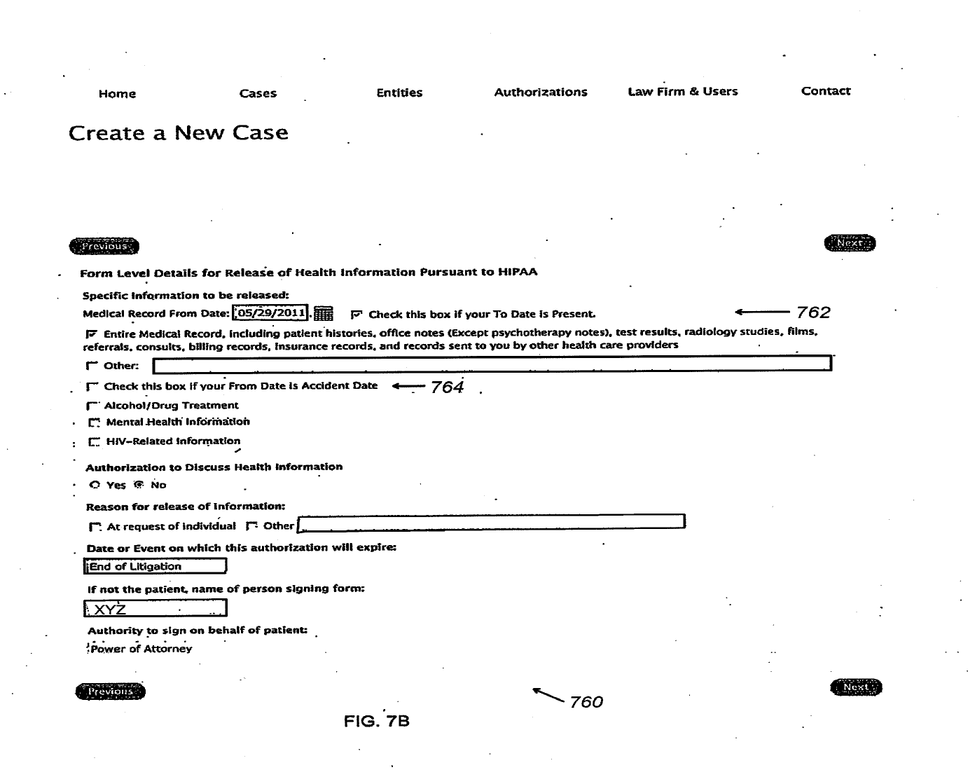

Process 200 then advances to state 240, where information regarding records to be released is entered or selected, such as via one of the interfaces 110-116. FIGS. 7A and 7B show example screen displays 700 and 760, respectively, that allow a user to enter or select information about the records to be released. In certain embodiments, screen display 700 includes a button (or similar selection item) 755 labeled Next that initiates generating the RIDS and/or the Power of Attorney (POA) documents and cover letters or other ancillary documents. Button 755 could have a different label, such as Generate Documents in other embodiments. Additional detail about the screen displays 700 and 760 will be provided hereinbelow. After completing state 240, process 200 advances to state 245 to generate the RIDs and any ancillary documents desired by the user based on the information entered or selected as described above.

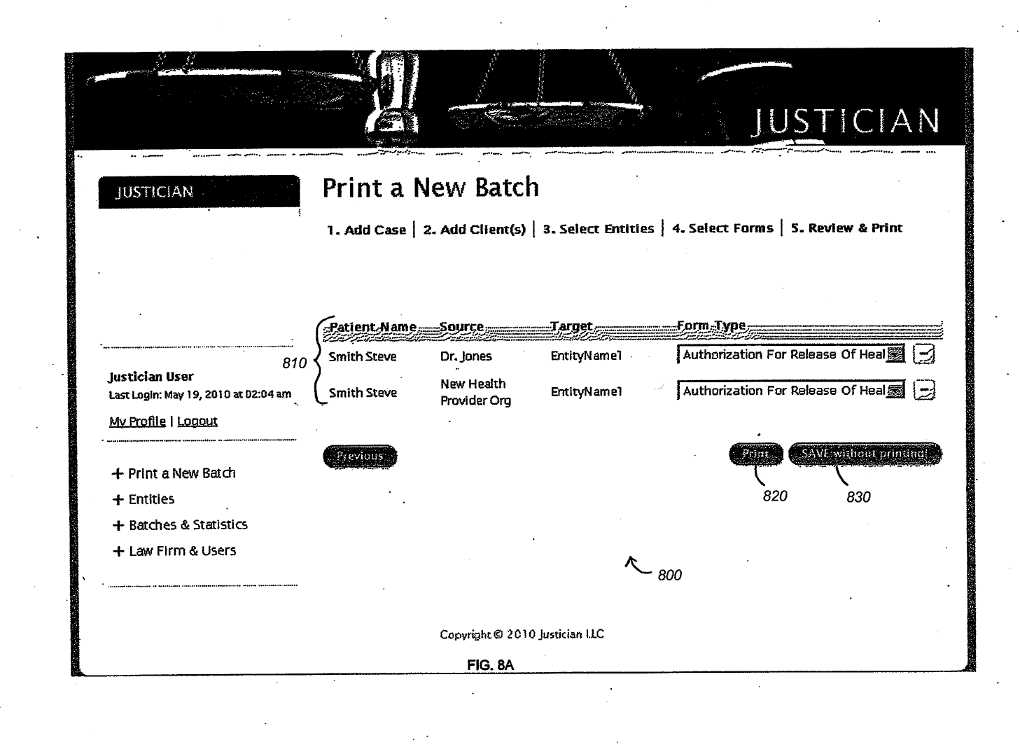

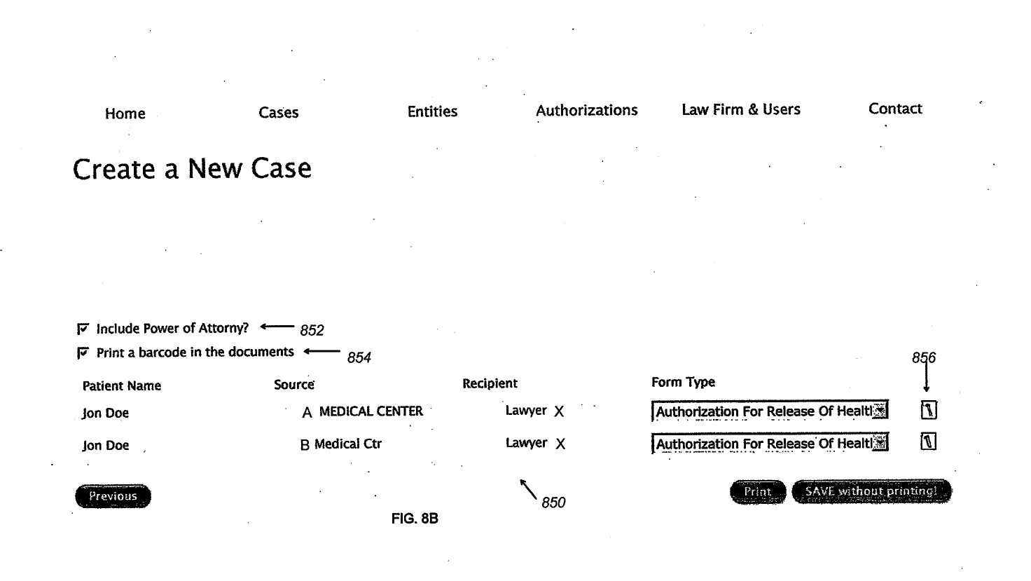

Process 200 continues at state 250, where the RID batches are reviewed and/or printed, such as via one of the interfaces 110-116. FIGS. 8A and 8B show example screen displays 800 and 850, respectively, that allow a user to review and/or print RID batches. Additional detail about the screen displays 800 and 850 will be provided hereinbelow.

The database may contain data regarding some or all of the holders of the information to be released such as doctors, hospitals, pharmacies, etc. as well as some or all of parties to whom the records are to be released such as law firms and insurance companies, so the end user may easily select them from a list rather than typing in their names and addresses. In some embodiments, the system assigns a unique request identifier, such as a request identification number, for each request. This identifier may be placed on the request or a cover sheet to be printed with each request. The cover sheet may contain instructions requesting it be returned with the requested records so that they can more easily be recognized upon return. In one embodiment, the request identification number may be printed on the RID or cover sheet as a barcode. There can be other ways to associate the request identification number with the RID, such as, for example, by use of a radio frequency identification (RFID).

It will be recognized by those skilled in the art that the RID and associated documentation may be transmitted to the holder of the records by any available transmission device and/or method, including, for example, electronically, or via facsimile, hand delivery, or mail.

Process 200 continues at a decision state 252 to determine if all the requested information has been received from the record holders or sources. If so, upon receipt of the requested records, in one embodiment, the end user records their receipt into the data repository either by manually recording the data, scanning a bar code, or other ways at state 260. Alternatively, the end user may, in one embodiment, scan the requested records and store them in the image repository, such as an image array.

In one embodiment, all data related to the RIDs is stored in a single repository of data, such as a Structured Query Language (SQL) server database, which may contain pointers to the images stored in the data repository. It will be recognized by those skilled in the art, however, that alternative storage arrangements are possible. For example, all data and images may be stored in a single repository or multiple distributed repositories. After the data is stored, process 200 completes at an end state 282.

However, if all the requested information records for a particular case or legal matter for which RIDs were sent are not received, as determined at decision state 252, process 200 advances through connector A 254 to state 270 in FIG. 2B. At state 270, process 270 determines which RIDs have not been responded to by the record holders or sources. This can be done by tracking the sent and received request identifiers, described above. For each RID that did not receive a reply, process 200 reprints or regenerates the RIDS in a batch mode and the reprinted or regenerated RIDs are retransmitted or sent to the information sources. In certain embodiments, ancillary documents will also be reprinted or regenerated. In one embodiment, the request identifier will be the same as the previous printing and sending of the RID. In another embodiment, the request identifier will be newly generated for the reprinting and sending of the RIDs.

After the regenerating or reprinting and retransmitting or sending of the RIDs at state 270, process 200 moves to a decision state 272 to determine if all the requested information has been received from the record holders or sources. If so, the received information is recorded in the system as previously described. However, if all the requested information has not been received from the record holders or sources after a selected time period, process 200 moves back to state 270 to determine the RIDs that have not been responded to and reprints and sends them. Process 200 completes at end state 282 when all the requested information has been received and recorded.

The system and method may be implemented using hardware, software or a combination thereof and may be implemented in one or more computer systems or other processing systems. In one embodiment, the system and method may be implemented using Ajax and Visual Basic programming.

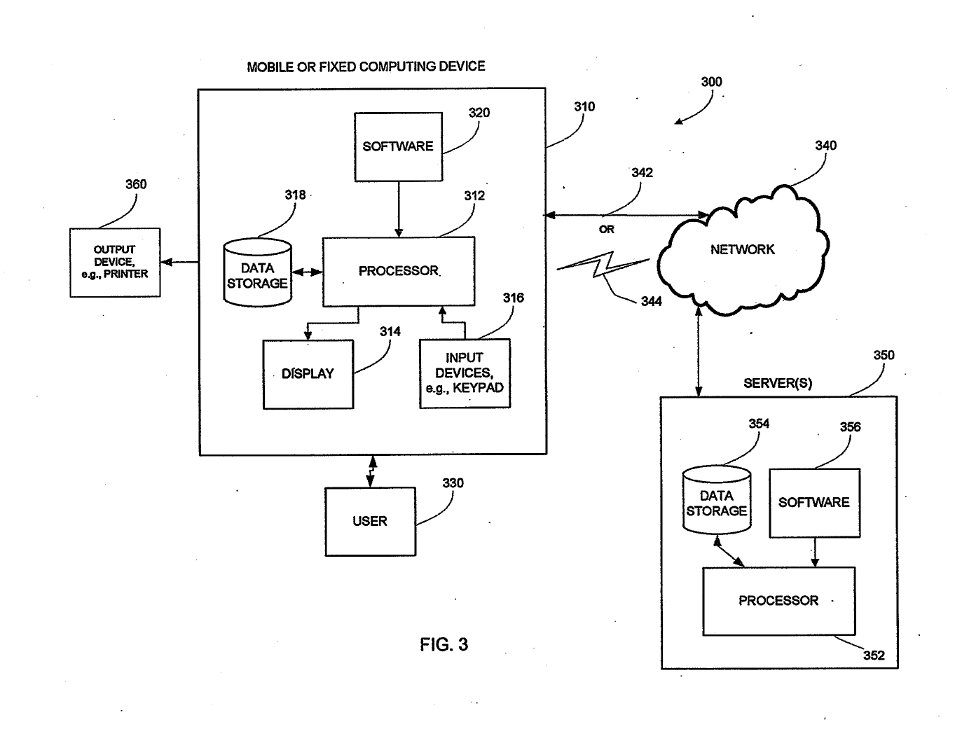

In one embodiment, one or more computer systems capable of carrying out the functionality are described herein. An example of such a computer system is shown in FIG. 3.

### Exemplary System Configuration

Referring to FIG. 3, an exemplary configuration 300 of components of an embodiment of the system will now be described. A mobile or fixed computing device 310 is operated by a user 330. The User Interface, such as interfaces 110-116, shown in FIG. 1 can be implemented on the mobile or fixed computing device. The computing device 310 can be a handheld computing device or other portable computing device such as a Palm, Pocket personal computer (PC), Linux based handheld, PDA, Tablet PC, a PC having a display. The computing device 310 in certain embodiments operates in a stand-alone (independent) manner. In other embodiments, the computing device 310 is in communication with one or more servers 350 via a network 340, such as the application server 150 shown in FIG. 1. The server(s) include one or processors 352, data storage 354, such as the Data Storage Module shown in FIG. 1, and system software 356 executed by the processor(s). In certain embodiments, the data storage 354 stores one or more databases used by the system, and stores records. The processor(s) 352 are in communication with the database(s) via a database interface, such as structured query language (SQL) or open database connectivity (ODBC). In certain embodiments, the data storage 354 is not included in server(s) 350, but is in data communication with the server(s) via the database interface. The connection from the computing device 310 to the network 340 can be a wireless or a satellite connection 344 or a wired or direct connection 342. In certain embodiments, the server(s) are part of a web site, such as on an intranet or the Internet.

When the computing device 310 is connected with the server(s) 350, the web site may optionally provide updates on new features. In another embodiment, the computing device runs only when connected to the server(s) 350.

The computing device 310 includes a processor 312, a display 314, and one or more input devices 316. The processor 312 is in data communication with a data storage 318 for storing data used by the system. In certain embodiments, the data storage 318 stores records. In other embodiments, the data storage includes one or more databases. System software 320 is executed by the processor 312. The system software 320 includes an application graphical user interface (GUI). The application GUI can include a database interface to the data storage 318 of the computing device. In certain embodiments, the software is loaded from the data storage 318. In embodiments where the computing device 310 communicates with a website, the processor utilizes browser software in place of or in addition to the software 320

### Example User Interface Screens

A graphical presentation of example graphical user interface (GUI) screens reflecting functions performed in accordance with an exemplary embodiment of the system and method will now be described.

FIG. 4A shows one embodiment of an example screen display 400 that allows a user to add a new case or edit an existing case. The user can input a unique file number 410, corresponding to the user's file naming convention. An Index number 412 and date of accident 414 can also be captured if desired. This screen also allows a user to access a previously created case file.

FIG. 4B shows another embodiment of an example screen display 450 that allows a user to add a new case or edit an existing case. An example input data string for File Number is shown at an input field 452 and an example date for Accident Date is shown at an input field 454. A button (or other selection mechanism) 456 allows the user to search for previously entered cases. In certain embodiments, a user entity is displayed on a portion of the screen 450.

It would be apparent to someone skilled in the art that these screens illustrate only certain embodiments. Additional case specific information could be captured, lookup tables and drop down lists could be utilized, the two functions of creation and editing an existing file could be split into two screens, etc.

FIG. 5A shows one embodiment of an example screen display 500 that allows demographic information 510 regarding the clients involved in the case, such as a patient, to be entered or edited. This information 510 may include one or more of certain items including first name, middle name, last name, title, date of birth, social security number, address, city, state, zip code, Medicare number and Medicaid number. In other embodiment, other information may be requested. Once entered, the clients' information is associated with the case. One or more clients can be entered for each case. New clients can be added by selecting an Add Patient option 520 or a similar mechanism. The entered information can be stored in the data repository 170, for example, by selecting a save button 530 or a similar mechanism. Client information that has been previously captured can also be edited through this screen.

FIG. 5B shows another embodiment of an example screen display 550 that allows demographic information to be entered or edited. An example client name is shown at a location 552 on the screen.

It would be apparent to someone skilled in the art that these screens illustrate only certain embodiments. Additional client specific information could be captured, the two functions of creation and editing an existing client could be split into two screens, pop up boxes could be utilized, etc.

FIG. 6A shows one embodiment of an example screen display 600 that allows a user to identify one or more holders or sources of information being requested. The holder can be picked from a list of potential holders 620 or manually entered 630. Categories can be selected 610 to help find one or more sources. A portion of the screen display 640 shows the selected source(s). In addition the user can identify one or more entities or targets to which the records are to be released. This could potentially include the user's own entity. The entities can be selected from a list of potential entities 660 or manually entered 670. Categories can be selected 650 to help find one or more targets. A portion of the screen display 680 shows the selected target(s). Information relating to manually entered holders or manually entered entities can be saved in a user's personal list for later use in a different case.

FIG. 6B shows another embodiment of an example screen display 690 that allows a user to identify one or more holders or sources of information being requested. Screen area 691 allows a name or address (or partial name or address) of a source entity to be entered and a category drop-down menu allows a category for the entity to be entered so as to narrow presentation of sources previously stored in the system. Screen area 692 shows an example of a first source having an entity type of Hospitals being selected and screen area 694 shows an example of a second source having an entity type of Doctors being selected. FIG. 6C shows another embodiment of an example screen display 695 that allows a user to identify one or more recipients or targets to which the records are to be released. In certain embodiments, screen 695 is displayed after a next button (or other selection mechanism) 693 (FIG. 6B) is selected. Screen area 696 allows a name or address (or partial name or address) of a recipient entity to be entered and a category drop-down menu allows a category for the entity to be entered so as to narrow presentation of recipients previously stored in the system. A Find button (or other selection mechanism) 698 initiates the system to access the previously stored recipients based on the entered name or address and/or category, and to display the results in a window on the display screen 695 to facilitate selection by the user. Screen area 697 shows an example of a recipient selected by the user having an entity type of Lawyers.

It would be apparent to someone skilled in the art that these screens illustrate only certain embodiments. The identification and management of holders and entities could be separated into two or more screens, drag and drop technology could be utilized for the selection process, additional documents to be added to the batch could be selected, etc.

FIG. 7A shows one embodiment of an example screen display 700 that allows the user to input specific information for each client that will be used to complete the RIDs. For example, one or more of specific information to be released 710, reason for release of information 720, date or event on which this authorization will expire 730, name of person signing the form if not the patient 740, and authority to sign on behalf of patient 750 can be used. For example, the specific information to be released may include a portion of a medical record, the entire medical record, alcohol/drug treatment, mental health information, HIV-related information or other information.

FIG. 7B shows another embodiment of an example screen display 760 that allows the user to input specific information for each client that will be used to complete the RIDs. In certain embodiments, screen area 762 allows a date from which the medical record is to be requested, and selection of a To Date check box informs the system that the date to which the record is desired is the current date. Screen area 764 shows a From Date check box, where selection of this check box informs the system that the date from which the record is desired is the Accident Date. The Accident Date can be entered in a previous screen or was previously stored. Where appropriate, default values are utilized for both screens 700 and 760.

It would be apparent to someone skilled in the art that these screens illustrate only certain embodiments. The functionality could be separated into one or more screens, the information could be displayed in an array format, pop-up boxes could be utilized, etc.

FIG. 8A shows one embodiment of an example screen display 800 that allows the user to preview, prior to printing, all of the RIDs that are included in the batch to be printed and are identified in a portion 810 of the screen. It allows the user to remove any number or none of the RIDs from the batch as well as open a RID-specific screen that would allow the user to edit data at the RID level. A button 820 or other mechanism allows the user to print RIDs. A button 830 or similar mechanism allows the user to save the RIDs without printing, such as, for example, when the user may want to print at a later time.

FIG. 8B shows another embodiment of an example screen display 850 that allows the user to preview the RIDs that are included in the batch to be printed. Screen area 852 shows a POA check box, where selection of this check box informs the system that a Power of Attorney is to be included in the documents to be printed. Screen area 854 shows a Barcode check box, where selection of this check box informs the system that a barcode corresponding to a request identifier for the particular request is to be printed in the documents. In other embodiments, the request identifier can be in other formats, such as QR codes or RFID. Selection of a button (or other selection mechanism) 856 initiates the system to open a RID-specific screen that allows the user to edit data at the RID level.

It would be apparent to someone skilled in the art that these screens illustrate only certain embodiments. The functionality could be split into two or more screens, drag and drop technology could be utilized, pop-up windows could be utilized, etc.

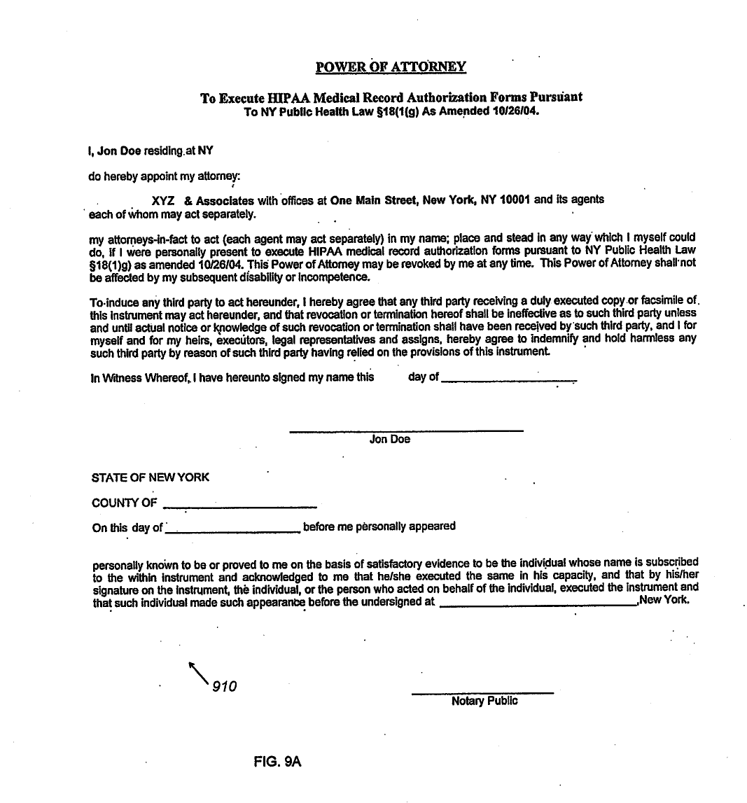

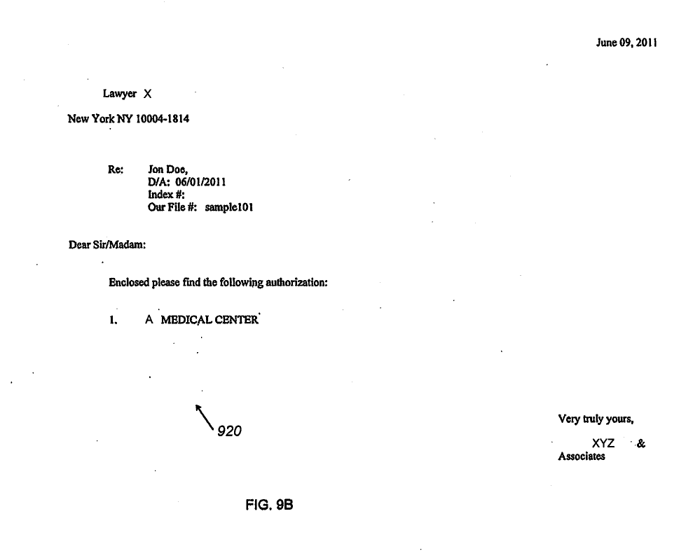

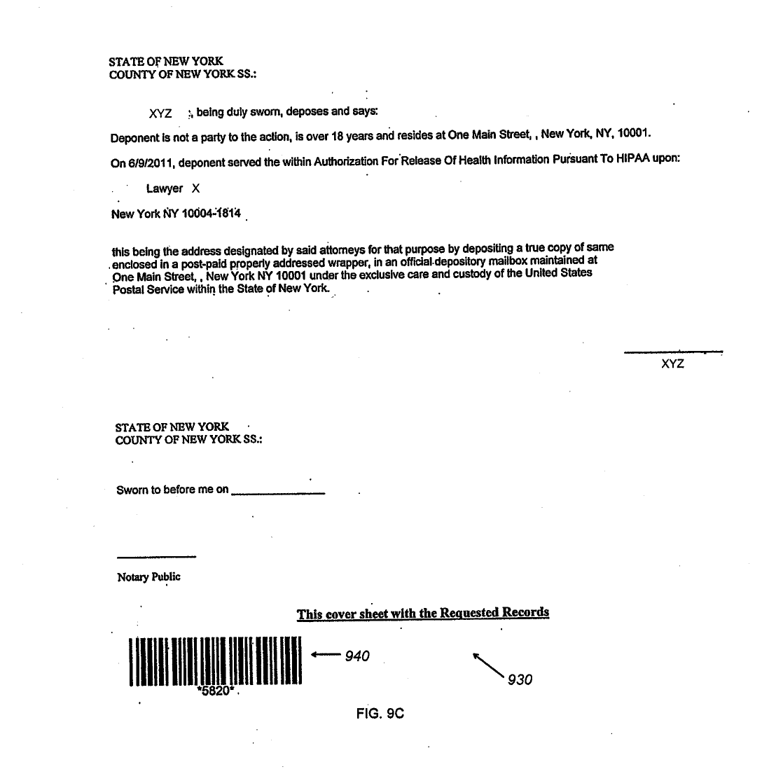

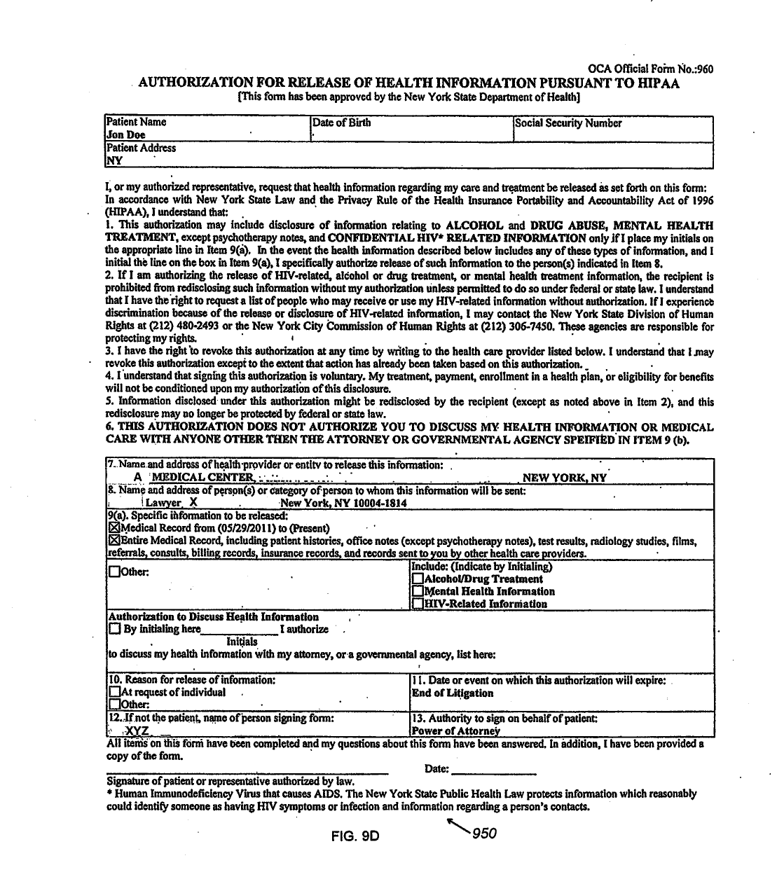

FIGS. 9A, 9B, 9C and 9D are example output documents generated by the system 100 shown in FIG. 1. FIG. 9A illustrated an example power of attorney document 910. FIG. 9B illustrates an example cover letter 920. FIG. 9C illustrates a cover sheet having a bar code 940. The bar code 940 is an example request identifier, described above. FIG. 9D illustrates an example Authorization for Release of Health Information Pursuant to HIPAA document 950.

### CONCLUSION

Specific blocks, sections, devices, functions, processes and modules may have been set forth. However, a skilled technologist will realize that there are many ways to partition the system, and that there are many parts, components, processes, modules or functions that may be substituted for those listed above.

While the above detailed description has shown, described and pointed out the fundamental novel features of the invention as applied to various embodiments, it will be understood that various omissions and substitutions and changes in the form and details of the system illustrated may be made by those skilled in the art, without departing from the intent of the invention. The foregoing description details certain embodiments of the invention. It will be appreciated, however, that no matter how detailed the foregoing appears, the invention may be embodied in other specific forms without departing from its spirit or essential characteristics. The described embodiment is to be considered in all respects only as illustrative and not restrictive and the scope of the invention is, therefore, indicated by the appended claims rather than by the foregoing description. All changes which come within the meaning and range of equivalency of the claims are to be embraced within their scope.

1. A computerized method of preparing release of information documents in a system having a processor and a storage, the method comprising:
receiving, at a processor associated with a party requesting medical information, first information identifying a particular legal action for which said medical information is needed;
receiving, at a processor associated with said requesting party, second information identifying one or more clients associated with the particular legal action;
receiving, at a processor associated with said requesting party, third information identifying a plurality of sources of medical information requiring a release of information document;
receiving, at a processor associated with said requesting party, fourth information identifying at least one recipient to which said medical information is to be provided;
batch processing, via a processor associated with said requesting party, the received first, second, third and fourth information;
generating, via a processor associated with said requesting party, a plurality of release of medical information documents, with one release of medical information document for each combination of said at least one recipient and one of the plurality of sources, wherein the batch processing includes processing the received first, second, third and fourth information as a batch without manual intervention; and
generating a physical form of said release of medical information documents.

2. The method of claim 1, additionally comprising receiving fifth information identifying particular data to be requested from the plurality of sources.

3. The method of claim 2, additionally comprising receiving particular released records, each particular record comprising the requested particular data, from at least a portion of the plurality of sources.

4. The method of claim 1, additionally comprising storing data indicative of each released record for the particular legal matter.

5. The method of claim 1, additionally comprising, after a predetermined time interval, determining sources from the plurality of sources that did not release records, and automatically regenerating by batch processing at least the release of information document for all sources that did not release records.

6. The method of claim 5, wherein the regenerating is based at least in part on stored data indicative of each requested record which has not been released for the particular legal matter.

7. The method of claim 1, additionally comprising printing a power of attorney document.

8. The method of claim 1, additionally comprising printing a generated release of information document.

9. (canceled)

10. The method of claim 1, additionally comprising selecting one or more of the generated release of information documents as a set for printing, and printing the selected set of documents.

11. The method of claim 1, additionally comprising assigning a unique request identifier for each request of release of information.

12. The method of claim 11, additionally comprising storing the unique request identifier for each request of release of information, and determining whether the requested information associated with the request identifier has been received.

13. A computerized system for preparing release of medical information documents, the system comprising:
a storage device;
a processor associated with a party requesting medical information, the processor being in data communication with the storage device, wherein the processor:
receives first information identifying a particular legal action for which said medical information is needed;
receives second information identifying one or more clients associated with the particular legal action;
receives third information identifying a plurality of sources of medical information requiring a release of information document;
receives fourth information identifying at least one recipient to which said medical information is to be provided;
batch processes the received first, second, third and fourth information; and
generates a plurality release of medical information documents, with one release of medical information document for each combination of said at least one recipient and one of the plurality of sources, wherein the batch processing includes processing the received first, second, third and fourth information as a batch without manual intervention; and
a component configured to generate a physical form of said release of medical information documents.

14. The system of claim 13, wherein the processor additionally receives fifth information identifying particular data to be requested from the plurality of sources.

15. The system of claim 14, wherein the processor additionally receives particular released records, each particular record comprising the requested particular data, from at least a portion of the plurality of sources.

16. The system of claim 13, wherein the processor additionally determines, after a predetermined time interval, sources from the plurality of sources that have not released records, and automatically regenerates at least the release of information document for all sources that did not release records.

17. The system of claim 13, wherein the system initiates a command for printing a generated release of information document.

18. A non-transitory computer readable medium storing computer readable program code embodied therein for preparing release of medical information documents, the computer readable code comprising instructions which when executed by a processor associated with a party requesting medical information perform the method of:
receiving first information identifying a particular legal action for which said medical information is needed;
receiving second information identifying one or more clients associated with the particular legal action;
receiving third information identifying a plurality of sources of medical information requiring a release of information document;
receiving fourth information identifying at least one recipient to which said medical information is to be provided;
batch processing the received first, second, third and fourth information; and
generating a plurality of release of information documents, with one release of medical information document for each combination of said at least one recipient and one of the plurality of sources, wherein the batch processing includes processing the received first, second, third and fourth information as a batch without manual intervention; and
generating a physical form of said release of medical information documents.

19. A computerized system for preparing release of medical information documents, the system comprising:
an interface, associated with a party requesting medical information, for receiving first information identifying a particular legal action for which said medical information is needed;
an interface, associated with said requesting party, for receiving second information identifying one or more clients associated with the particular legal action;
an interface, associated with said requesting party, for receiving third information identifying a plurality of sources of medical information requiring a release of information document;
an interface, associated with said requesting party, for receiving fourth information identifying at least one recipient to which said medical information is to be provided;
a processor, associated with said requesting party, for batch processing the received first, second, third and fourth information; and
a component, associated with said requesting party, for generating a plurality of release of medical information documents, with one release of medical information document for each combination of said at least one recipient and one of the plurality of sources, wherein the batch processing includes processing the received first, second, third and fourth information as a batch without manual intervention; and
a component for generating a physical form of said release of medical information documents.

20. The system of claim 13, wherein the processor additionally selects one or more of the generated release of information documents as a set for printing, and initiates printing of the selected set of documents.

21. The system of claim 13, wherein the processor additionally assigns a unique request identifier for each request of release of information.

22. The method of claim 1, additionally comprising sending the generated release of medical information documents to each of the sources.

23. The system of claim 13, additionally comprising a component configured to send the generated release of medical information documents to each of the sources.
